(19) United States
(12) Patent Application Publication
(10) Pub. No.: US 2011/0319560 A1
(43) Pub. Date: Dec. 29, 2011

(54) Pressure-Sensitive Adhesive Mass

(75) Inventors: Kirstin Weiland, Hamburg (DE); Uwe Schuemann, Pinneberg (DE); Daniel Klier, Reinbek (DE); Marc Husemann, Hamburg (DE)

(73) Assignee: TESA SE, Hamburg (DE)

(21) Appl. No.: 13/202,548

(22) PCT Filed: Feb. 5, 2010
(86) PCT No.: PCT/EP2010/051439

§ 371 Date: Sep. 15, 2011

(30) Foreign Application Priority Data
Feb. 20, 2009 (DE) 102009009757.0

(51) Int. Cl. C09J 175/08; C09J 11/06

(52) U.S. Cl. 524/720

(57) ABSTRACT

The present invention relates to a pressure-sensitive adhesive mass based on polyurethane, wherein the polyurethane is composed of the following starting materials in the specified proportions, said starting materials being reacted catalytically with each other: a) at least one aliphatic or alicyclic polyisocyanate, wherein the functionality thereof is less than or equal to 3 in each case; b) a combination of at least one polypropylene glycol diol and at least one polypropylene glycol triol, wherein the ratio of the number of hydroxyl groups of the diol component to the number of hydroxyl groups of the triol component is less than 10, wherein the ratio of the number of isocyanate groups to the total number of hydroxyl groups is between 0.65 and 1.2, and wherein the diols and triols are selected and combined alternatively as follows in each case: diols having a molecular weight of less than or equal to 1000 are combined with triols having a molecular weight greater than or equal to 1000, diols having a molecular weight of great than 1000 are combined with triols having a molecular weight less than 1000; (c) at least one light stabilizer based on an aromatically substituted triazine having a proportion of 0.2-2 wt % and at least one amine-hindered light stabilizer having a proportion of 0.2-2 wt %; d) at least one antioxidant based on a sterically hindered phenol having a proportion of 0.2-2 wt %; e) a carbodiimide having a proportion of 0.25-2.5 wt %.

The present invention relates to a pressure-sensitive adhesive, intended more particularly for the bonding of optical components, as claimed in claim 1.

Pressure-sensitive adhesives (PSAs) are nowadays used very diversely. In the industrial sector, for instance, there exists a very wide variety of applications. Adhesive tapes based on PSAs are used in especially high numbers in the electronics segment or in the consumer electronics segment. Owing to the high numbers of units, pressure-sensitive adhesive tapes can be employed here very rapidly and easily, meaning that other operations, such as riveting or welding, for example, would be too costly and inconvenient. Besides their normal joining function, these pressure-sensitive adhesive tapes may be required to take on additional functions. Examples thereof may include thermal conductivity, electrical conductivity or else an optical function. In the latter case, for example, pressure-sensitive adhesive tapes are used which have light-absorbing or light-reflecting functions. An example of another optical function is a suitable luminous transmittance. Here, pressure-sensitive adhesive tapes and PSAs are used that are very transparent, have no intrinsic coloration, and also possess a high light stability.

In many cases, a PSA for optical purposes, as well as the joining function, has the function of excluding air, since air has a refractive index of 1 and the optical films or glasses have a refractive index which is generally much larger. On transition from air to the optical component, the difference in refractive indices leads to reflection, which reduces the transmission. One way of solving this problem is provided by antireflection coatings, which facilitate the transition of the light into the optical component, and reduce reflection. An alternative or additional option is to use an optical PSA with a refractive index similar to that of the optical component. This significantly minimizes the reflection at the optical component, and increases the transmission.

One typical application is, for example, the bonding of touch panels to the LCD or OLED display. (indium tin oxide) for capacitive touch panels. Further typical applications are use as a single-sided pressure-sensitive adhesive tape for the reinforcement of glass, as antisplinter protection, the bonding of ITO films (indium tin oxide) for capacitive touch panels, or surface protection films for optical films, such as polarizer films, for example.

Optical components, such as films or glasses, generally have a relatively high refractive index, and so the requirement here is for PSAs which likewise possess a high refractive index. The majority of substrates for optical bonding, accordingly, have a refractive index of 1.45-1.70. A further requirement lies in the neutrality of the PSA formulation. Accordingly, the PSA ought not to contain any acid functions, which on contact with ITO films, for example, can adversely affect the electrical conductivity over a relatively long period of time. One further requirement lies in the UV stability. Accordingly, for outdoor applications, for example, optical PSAs are likewise employed, but are exposed to UV light.

For transparent adhesive bonds, a multiplicity of acrylate PSAs are known, which are used in the optical sector and have very different refractive indices. U.S. Pat. No. 6,703,463 describes acrylate PSAs which have a refractive index of below 1.40. This is achieved by means of fluorinated acrylate monomers. The refractive index is therefore significantly below the desired range. JP 2002-363523 A describes acrylate PSAs having a refractive index of between 1.40 and 1.46. Here again, fluorinated acrylate monomers are used. This refractive index as well is significantly below the desired range. Also commercially available are various acrylate pressure-sensitive adhesive tapes, such as 3M 8141, for example. These conventional acrylate PSAs are situated within a refractive index range of 1.47 to 1.48.

US 2002/0098352 A1 describes acrylate PSAs with aromatic comonomers that have a refractive index of 1.49-1.60. This is within the desired range, but the aromatics are also associated with disadvantages. Hence they are able to absorb UV light in the shortwave range, thereby adversely affecting the transmission stability and also the yellowing tendency.

EP 1 652 889 A1 describes, for optical applications, PSA formulations that are based on polydiorganosiloxanes. Silicone compounds generally have a low refractive index, and so these adhesives are not optimally suitable for optical applications.

Additionally known as PSAs are polyurethane PSAs. Based on polyurethane, double-bond-containing polyol components which carry hydroxyl groups are employed. Polyurethane PSAs on this basis are set out, for example, in JP 02003476 A, WO 98/30648 A1, JP 59230076 A, JP 2001-146577 A, U.S. Pat. No. 3,879,248 A, U.S. Pat. No. 3,743,616 A, U.S. Pat. No. 3,743,617 A, U.S. Pat. No. 5,486,570 A and U.S. Pat. No. 3,515,773 A. A disadvantage is the oxidative sensitivity of these PSAs, brought on by the double bonds in the main chain of the polymer. After a certain time, this leads to film hardening and/or yellowing and/or dulling of the tacky surface.

DE 21 39 640 A describes a PSA based on an aromatic diisocyanatourethane. A particular disadvantage with this PSA is the yellowing tendency typical of aromatic polyurethanes.

Hence there continues to be a need for an improved PSA which does not have the disadvantages identified above and is therefore suitable especially for optical applications. A suitable adhesive ought more particularly to have high optical transparency and also high UV stability.

The present invention solves the above-described problem by means of a PSA as claimed in claim 1. Preferred embodiments and developments are subject matter of the dependent claims.

The invention accordingly provides a pressure-sensitive adhesive based on polyurethane, wherein the polyurethane is composed of the following starting materials, reacted catalytically with one another, in the stated proportions:
a) at least one aliphatic or alicyclic polyisocyanate, the functionality thereof in each case being less than or equal to 3
b) a combination of at least one polypropylene glycol diol and at least one polypropylene glycol triol,
   where the ratio of the number of hydroxyl groups in the diol component to the number of hydroxyl groups in the triol component is less than 10, preferably between 0.2 and 5,
   where the ratio of the number of isocyanate groups to the total number of hydroxyl groups is between 0.65 and 1.2, preferably between 0.95 and 1.05, more preferably between 1.0 and 1.05,
   and where the diols and triols alternatively are each selected and combined as follows:
      diols having a molecular weight of less than or equal to 1000 are combined with triols whose molecular weight is greater than or equal to 1000, preferably greater than or equal to 3000,
      diols having a molecular weight of greater than 1000 are combined with triols whose molecular weight is less than 1000
c) at least one light stabilizer based on an aromatically substituted triazine, with a fraction of 0.2%-2% by weight, and at least one aminically hindered light stabilizer, with a fraction of 0.2%-2% by weight
d) at least one aging inhibitor based on a sterically hindered phenol, with a fraction of 0.2%-2% by weight
e) a carbodiimide, with a fraction of 0.25%-2.5% by weight.

The PSA therefore in particular has no aromatic comonomers, and yet it is possible to set a high refractive index, more particularly, indeed, of greater than 1.48.

The luminous transmittance of a PSA formulation of this kind is more particularly greater than 86%, and the haze less than 5%, in accordance with ASTM D 1003. Consequently, the PSA is suitable particularly for adhesive bonds in the optically transparent range. This PSA is distinguished by a high refractive index, high transmittance, and high UV stability. The PSA is used preferably for the bonding of optical components in consumer electronics items.

In the design and configuration of optical components, such as glass windows and films, for example, it is necessary to give consideration to the interaction of the materials used with the nature of the irradiated light. In one derived version, the law of conservation of energy takes on the following form:

T(λ)+p(λ)+a(λ)=1

where T(λ) describes the fraction of light transmitted, p(λ) describes the fraction of light reflected, and a(λ) describes the fraction of light absorbed (λ: wavelength), and where the overall intensity of the irradiated light is standardized to 1. Depending on the application of the optical component, it is appropriate to optimize single terms out of these three terms and to suppress the others. Optical components designed for transmittance are to be distinguished by values for T(λ) that are close to 1. This is achieved by reducing the amount of p(λ) and a(λ).

Polyurethane-based PSAs do not normally exhibit significant absorption in the visible range, i.e., in the wavelength range between 400 nm and 700 nm. This can easily be verified by measurements using a UV-Vis spectrophotometer. Of critical interest, therefore, is p(λ). Reflection is an interface phenomenon which is dependent on the refractive indices n_{d,i} of two phases i that are in contact, as described by the Fresnel equation:

$$p ( λ ) = {( \frac{{n}_{d , 2} - {n}_{d , 1}}{{n}_{d , 2} + {n}_{d , 1}} )}^{2}$$

For the case of isorefractive materials, for which n_{d,2}=n_{d,1}, p(λ) will be =0. This explains the need to adapt the refractive index of a PSA to be used for optical components to that of the materials that are to be bonded. Typical values for various such materials are set out in Table 1.

TABLE 1

| Material | Refractive index n_{d} |
|---|---|
| Quartz glass | 1.458 |
| Borosilicate crown (BK7) | 1.514 |
| Borosilicate crown | 1.518 |
| Flint | 1.620 |

(Source: Pedrotti, Pedrotti, Bausch, Schmidt, Optik, 1996, Prentice-Hall, Munich. Data for X = 588 nm)

In order to produce polyurethanes with sufficient light stability and with high luminous transmittance, it is necessary, as is known, to use aliphatic or alicyclic polyisocyanates and/or polyisocyanates with isocyanate groups that are not aromatically attached. It has surprisingly been found that aliphatic or alicyclic polyisocyanates are suitable for also producing the rest of the desired profile of properties of the polyurethane PSA, in line with the requirements for optical applications. Hence the surface-specific selectivity of the pressure-sensitive adhesive properties can be adjusted through use of aliphatic or alicyclic polyisocyanates, but also PSAs with high transparency.

In contrast to the aliphatic or alicyclic polyisocyanates, the use of aromatic polyisocyanates leads to discolorations and to adverse technical adhesive properties.

In one advantageous embodiment, polyisocyanates used are aliphatic or alicyclic diisocyanates. These diisocyanates form a better network and so allow optimization of the technical adhesive properties in respect of cohesion and reversibility.

Particularly advantageous is the use of aliphatic or alicyclic diisocyanates having in each case an unsymmetrical molecular structure—in which, in other words, the two isocyanate groups each possess a different reactivity. In particular, the otherwise typical tendency of pressure-sensitively adhesive polyurethanes to undergo “fatty exudation” is reduced significantly through the use of aliphatic or alicyclic diisocyanates having an unsymmetrical molecular structure. Unsymmetrical molecular structure means that the molecule possesses no elements of symmetry (for example, mirror planes, axes of symmetry, centers of symmetry), in other words that no symmetry operation can be performed that produces a molecule congruent with the starting molecule.

Further examples of polyisocyanates suitable for the PSA are as follows: butane 1,4-diisocyanate, tetramethoxybutane 1,4-diisocyanate, hexane 1,6-diisocyanate, ethylene diisocyanate, 2,2,4-trimethylhexamethylene diisocyanate, ethylethylene diisocyanate, dicyclohexylmethane diisocyanate, 1,4-diisocyanatocyclohexane, 1,3-diisocyanatocyclohexane, 1,2-diisocyanatocyclohexane, 1,3-diisocyanatocyclopentane, 1,2-d iisocyanatocyclopentane, 1,2-diisocyanatocyclobutane, 1-isocyanatomethyl-3-isocyanato-1,5,5-trimethylcyclohexane (isophorone diisocyanate), 1-methyl-2,4-diisocyanatocyclohexane, 1,6-diisocyanato-2,2,4-trimethylhexane, 1,6-diisocyanato-2,4,4-trimethylhexane, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)cyclohexane, 1-isocyanato-2-(2-isocyanatoeth-1-yl)cyclohexane, 2-heptyl-3,4-bis(9-isocyanatononyl)-1-pentylcyclohexane, norbornane diisocyanatomethyl, chlorinated, brominated, sulfur- or phosphorus-containing aliphatic or alicyclic diisocyanates, and also derivatives of the diisocyanates listed, more particularly dimerized or trimerized types.

One particularly preferred embodiment uses isophorone diisocyanate.

In terms of the physical and quantitative composition of the reactants that are reacted with the polyisocyanate, it is preferred to use aliphatic diols. A combination of at least one polypropylene glycol diol and at least one polypropylene glycol triol is used in order to prepare polyurethanes having high bond strength and high transmittance.

As polypropylene glycols it is possible to use all commercial polyethers based on propylene oxide and on a difunctional starter, in the case of the diols, and on a trifunctional starter, in the case of the triols. These include not only the polypropylene glycols prepared conventionally, in other words, generally, with a basic catalyst, such as potassium hydroxide, for example, but also the particularly pure polypropylene glycols which are prepared with DMC (double metal cyanide) catalysis, the preparation of which is described in, for example, U.S. Pat. No. 5,712,216 A, U.S. Pat. No. 5,693,584 A, WO 99/56874 A1, WO 99/51661 A1, WO 99/59719 A1, WO 99/64152 A1, U.S. Pat. No. 5,952,261 A, WO 99/64493 A1, and WO 99/51657 A1.

A characteristic of the DMC-catalyzed polypropylene glycols is that the “nominal” or theoretical functionality of exactly 2 in the case of the diols and exactly 3 in the case of the triols is also approximately achieved in actual fact. With the conventionally prepared polypropylene glycols, the “true” functionality is always slightly lower than the theoretical functionality, particularly in the case of polypropylene glycols of relatively high molecular weight. The reason is a secondary rearrangement reaction of the propylene oxide to form allyl alcohol.

Furthermore, it is also possible to use all polypropylene glycol diols and triols which incorporate, through copolymerization, ethylene oxide, this being the case in numerous commercial polypropylene glycols, in order to achieve an increased reactivity toward isocyanates.

By varying the proportion of the number of hydroxyl groups of the diol to that of the triol within the limits imposed, it is possible for the bond strength to be influenced and custom-tailored to the application. It has surprisingly been found that the bond strength increases the higher the ratio of the number of diol OH groups to that of triol OH groups. The bond strength range which can be set within the stated limits is situated approximately within a range from 1.0 to 15.0 N/cm, measured on steel in accordance with PSTC-1 (see description of the test methods) and as a function of the PSA coatweight.

Particularly advantageous is the use of a bismuth carboxylate-containing or bismuth carboxylate derivative-containing catalyst or catalyst mixture, the use of which for accelerating polyurethane reactions is known. A catalyst of this kind considerably directs the pressure-sensitive adhesive properties of the polyurethane in such a way that they are given a surface-specific selectivity. Examples of bismuth carboxylates are bismuth trisdodecanoate, bismuth trisdecanoate, bismuth trisneodecanoate, bismuth trisoctanoate, bismuth trisisooctanoate, bismuth trishexanoate, bismuth trispentanoate, bismuth trisbutanoate, bismuth trispropanoate or bismuth trisacetate.

It is, however, also possible to use all other catalysts known to the skilled person, such as tertiary amines or organotin compounds, for example.

In one possible embodiment, the polyurethane-based PSA comprises other formulating ingredients such as, for example, additional catalysts or rheological additives.

Examples of rheological additives are fumed silicas, phyllosilicates (for example, bentonites), high molecular mass polyamide powders or castor oil derivative powders. In the choice of the rheological additives it is necessary to ensure that they are selected so as not adversely to affect the transmittance of the PSA. This is achieved by ensuring that these additives are of a size order (spatial extent) that lies within the range of the wavelength of visible light (400-800 nm) or below.

In the selection of these additives it is also necessary to ensure that these substances have no tendency to migrate toward the substrate to be bonded, in order that there is no resultant spotting. For the same reason, the concentration of these substances, especially of those that are liquid, in the composition as a whole should be minimized. The additional use of plasticizers or tackifier resins ought therefore, as far as possible, to be avoided—in certain cases, however, their use may nevertheless make sense.

In order further to accelerate the reaction between the isocyanate component and the component reacting with the isocyanate, it is possible in addition to use all of the catalysts known to the skilled person, such as tertiary amines or organotin compounds, for example.

The light stabilizers c) are selected from the group of the substituted triazines. The triazines are selected such that they exhibit high compatibility with the polyurethanes.

This is achieved by means of substituents, for example. Hence preferred embodiments of the triazines have at least one aromatic substituent, more preferably at least 2 aromatic substituents, and very preferably 3 aromatic substituents. These aromatics may themselves in turn be substituted by at least one aliphatic substituent. In the simplest form this may be a methyl group. However, other substituents are possible as well, such as hydroxyl groups, ether groups, aliphatic chains having 2 to 20 C atoms, which are linear, branched or cyclic and which may also in turn contain up to 5 oxygen atoms in the form of ether groups, hydroxyl groups, ester groups, carbonate groups. Examples of light stabilizers of commercial kind are available from Ciba under the brand name Tinuvin®. Hence, for example, Tinuvin® 400, Tinuvin® 405, Tinuvin® 479, and Tinuvin® 477 are suitable light stabilizers that can be employed.

As further light stabilizers, hindered amines are used. Particular preference is given to using substituted N-methylpiperidine derivatives. These are sterically hindered, for example, in positions 1 and 5, by aliphatic groups, such as methyl groups, for example. With particular preference, four methyl groups are used for the steric hindering. In order to achieve high solubility with the polyurethane, and also in order to increase the evaporation temperature, long aliphatic substituents are employed. The substituents may be linear, cyclic or branched, contain up to 20 C atoms, contain up to 8 O atoms, which take the form, for example, of ester groups, ether groups, carbonate groups or hydroxyl groups. For the effect it is possible to use compounds having only one N-methylpiperidine group. Also known, however, are dimeric N-methylpiperidine derivatives which have a light stabilizer function. These can also be combined with the monomeric compounds.

As aging inhibitors d), sterically hindered phenols are used. Sterically hindered phenols in one preferred embodiment have tert-butyl groups in both positions ortho to the hydroxyl group. In order to allow good solubility and a high evaporation temperature to be attained, the sterically hindered phenols ought additionally to be substituted. The substituents may be linear, cyclic or branched, contain up to 20 C atoms, contain up to 8 O atoms, which may take the form, for example, of ester groups, ether groups, carbonate groups or hydroxyl groups. Commercially available compounds are, for example, Irganox® 1135 or Irganox® 1330 from Ciba.

As a further component, carbodiimides are admixed to the polyurethanes. In the selection of the carbodiimides, attention should be paid, again, to compatibility with the polyurethanes and to the boiling or evaporation temperature. Accordingly, numerous carbodiimides, such as dicyclohexylcarbodiimide (boiling point 122° C.) or N,N-diisopropylcarbodiimide (boiling point 148° C.), for example, are not suitable, since their vapor pressure is too high. It is preferred, for example, to use 1-ethyl-3-(3-dimethylaminopropyl)carbodiimide hydrochloride, which has a melting point of approximately 110° C. Furthermore, however, there are also polymeric carbodiimides known, of the kind available commercially, for example, from Rheinhausen in the form of Stabaxol® P 200.

In addition it is possible to add further aging inhibitors. Having emerged as particularly advantageous is the combination of substituted phenols which are at least doubly substituted and which in both substituents carry at least one sulfur atom, and also aromatically substituted phosphites. Commercial examples of S-containing sterically hindered phenols are Irganox® 1520 or Irganox® 1726 from Ciba. Commercial examples of aromatically substituted phosphites are Irgafos® 168, Irgafos® 126, Irgafos® 38, Irgafos® P-EPQ or Irgafos® 12 from Ciba.

### Process

The PSA in one preferred embodiment is prepared continuously by the process described below:

A vessel A is charged essentially with the premixed polyaliphatic glycol combination (polyol component), and a vessel B essentially with the isocyanate component; if desired, the other formulating ingredients may have already been admixed to these components beforehand, in a customary mixing procedure. The polyol component and the isocyanate component are conveyed via precision pumps through the mixing head or the mixing pipe of a multicomponent mixing and metering unit, where they are mixed homogeneously and brought to reaction. Immediately thereafter, the mixed components, reacting chemically with one another, are applied to a carrier material in web form which is moving preferably at a constant speed. The nature of the carrier material is guided by the article to be produced. The carrier material coated with the reacting polyurethane composition is passed through a heating tunnel, in which the polyurethane composition cures to form the PSA. The coatweight of the polyurethane composition is freely selectable. It is guided by the article to be produced. The coated carrier material, finally, is wound up in a winding station.

The process described makes it possible to operate without solvent and without water. Solvent-free and water-free operation is the preferred procedure, but is not absolutely necessary. In order, for example, to obtain particularly low coatweights, the components may be appropriately diluted.

In order to improve the anchoring of the polyurethane composition to the web-form carrier materials, it is possible to use all known methods of surface pretreatment, such as, for example, corona pretreatment, flame treatment, gas-phase treatment (for example, fluorination). Likewise, all known methods of priming may be used, it being possible for the primer coat to be applied to the carrier material from solutions or dispersions, or else in an extrusion or coextrusion procedure.

In order to improve the unwind properties of the wound roll, the reverse face of the web-form material may be coated, as a preliminary, with a release coating (release varnish) or else may carry a coextruded or extruded-on reverse-face coating which has release qualities.

Further details, objectives, features, and advantages of the present invention will be elucidated in more detail below by reference to preferred exemplary embodiments. In the drawing,

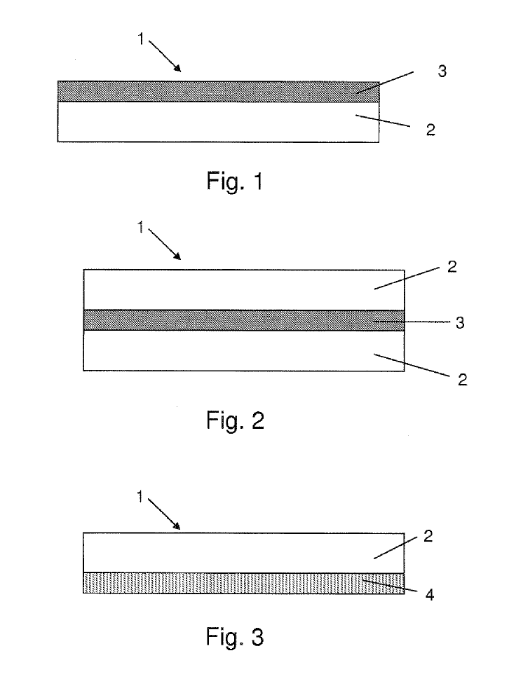

FIG. 1 shows a single-sided pressure-sensitive adhesive tape,

FIG. 2 shows a double-sided pressure-sensitive adhesive tape,

FIG. 3 shows a carrier-free pressure-sensitive adhesive tape (adhesive transfer tape).

FIG. 1 shows a single-sidedly adhering pressure-sensitive adhesive tape (PSA tape) 1 for use in the bonding of optical components, more particularly of optical films. The PSA tape 1 has an adhesive layer 2 produced by coating an above-described PSA onto a carrier 3. The PSA coatweight is preferably between 5 and 250 g/m². The PSA has a transmittance of at least 86% in particular in the visible range of light, so making it particularly suitable for optical application.

For application in the bonding of optical components, a transparent carrier 2 is also employed, as carrier 2. The carrier 2 is therefore likewise transparent in the range of visible light, and thus preferably has a transmittance of—likewise—at least 86%.

Additionally provided (not shown) there may also be a release film which lines and protects the adhesive layer 2 prior to the use of the PSA tape 1. The release film is in this case removed from the adhesive layer 2 prior to use.

The transparent PSA may preferably be protected with a release film. It is possible, furthermore, for the carrier film to be provided with one or more coatings.

The product construction depicted in FIG. 2 shows a PSA tape 1 having a transparent carrier 3, which is coated on both sides with a PSA and thus has two adhesive layers 2. The PSA coatweight per side is again preferably between 5 and 250 g/m².

With this embodiment as well, it is preferred for at least one adhesive layer 2 to be lined with a release film. In the case of a rolled-up adhesive tape, this one release film may where appropriate also line the second adhesive layer 2. It is also possible, though, for a plurality of release films to be provided.

A further possibility is for the carrier film to be provided with one or more coatings. Moreover, only one side of the PSA tape may be equipped with the inventive PSA, and a different transparent PSA may be used on the other side.

The product construction depicted in FIG. 3 shows a PSA tape 1 in the form of an adhesive transfer tape, i.e., a carrier-free PSA tape 1. For this purpose, the PSA is coated onto one side of a release film 4, and so forms a pressure-sensitive adhesive layer 2. The PSA coatweight is in this case typically between 5 and 250 g/m². If desired, this pressure-sensitive adhesive layer 2 is also lined on its second side with a further release film. For the use of the PSA tape, the release films are in this case removed.

As an alternative to release films it is also possible, for example, to use release papers or the like. In that case, however, the surface roughness of the release paper ought to be reduced, in order to produce a very smooth PSA side.

### Carrier Films

As carrier films it is possible to use a large number of highly transparent polymer films. Specific highly transparent PET films can be used in particular. Suitability is thus possessed, for example, by films from Mitsubishi with the trade name Hostaphan™ or from Toray with the trade name Lumirror™. The haze, a measure of the clouding of a substance, ought in one preferred embodiment to have a value of less than 5% in accordance with ASTM D 1003. High haze denotes low visibility through the substance in question. The luminous transmittance at 550 nm is preferably greater than 86%, more preferably greater than 88%. A further very preferred species of the polyesters is represented by the polybutylene terephthalate films.

Besides polyester films it is also possible to use highly transparent PVC films. These films may include plasticizers in order to increase the flexibility. Moreover, PC, PMMA, and PS films can be used. Besides pure polystyrene, it is also possible to use other comonomers, such as butadiene, for example, in addition to styrene, for the purpose of reducing the propensity to crystallization.

Moreover, polyethersulfone films and polysulfone films can be used as carrier materials. These films are obtainable, for example, from BASF under the tradename Ultrason™ E and Ultrason™ S. It is also possible, furthermore, with particular preference, to use highly transparent TPU films. These films are available commercially, for example, from Elastogran GmbH. Use may also be made of highly transparent polyamide films and copolyamide films, and also of films based on polyvinyl alcohol and polyvinyl butyral.

Besides single-layer films it is also possible to use multilayer films, which are produced by coextrusion, for example. For this purpose it is possible to combine the aforementioned polymer materials with one another.

The films, further, may be treated. Thus, for example, vapor deposition may be performed, with zinc oxide, for example, or else varnishes or adhesion promoters may be applied. One further possible additization is represented by UV protectants, which may be present as additives in the film or may be applied as a protective layer.

The film thickness in one preferred embodiment is between 4 μm and 150 μm, more preferably between 12 μm and 100 μm.

The carrier film may, for example, also have an optical coating. Particularly suitable optical coatings are coatings which reduce the reflection. This is achieved, for example, through a reduction in the refractive index difference for the air/optical coating transition.

Generally speaking, a distinction may be made between single-layer and multilayer coatings. In the simplest case, MgF₂ is used as a single layer to minimize the reflection. MgF₂ has a refractive index of 1.35 at 550 nm. Furthermore, for example, metal oxide layers can be used in different layers to minimize the reflection. Typical examples are layers of SiO₂ and TiO₂. Examples of further suitable oxides include hafnium oxide (HfO₂), magnesium oxide (MgO), silicon monoxide (SiO), zirconium oxide (ZrO₂), and tantalum oxide (Ta₂O₅). It is additionally possible to use nitrides, such as SiNₓ, for example. Moreover, fluorinated polymers can also be used as a low refractive index layer. These layers are also used very frequently in combination with the aforementioned layers of SiO₂ and TiO₂. Furthermore, sol-gel processes can be employed. Here, for example, silicones, alkoxides and/or metal alkoxides are used in the form of mixtures, and coating takes place with these mixtures. Siloxanes, therefore, are also a widespread basis for reflection-reducing layers.

The typical coating thicknesses are between 2 and 1000 Å (0.2 to 100 nm), preferably between 100 and 500 Å (10 to 50 nm). In some cases, depending on layer thickness and chemical composition of the individual or two or more optical layers, color changes occur, which may in turn be controlled or modified through the thickness of the coating. For the siloxane process coated from solution it is also possible to obtain layer thicknesses of greater than 1000 Å (100 nm).

A further possibility for reducing the reflection lies in the production of particular surface structures. Hence there is the possibility of porous coating and of the generation of stochastic or periodic surface structures. In this case the distance between the structures ought to be significantly smaller than the wavelength range of visible light.

Besides the aforementioned process of solvent coating, the optical layers may be applied by vacuum coating methods, such as CVD (chemical vapor deposition) or PIAD (plasma ion assisted deposition), for example.

### Release Film

To protect the open pressure-sensitive adhesive it is preferably lined with one or more release films. As well as the release films it is also possible—albeit not very preferably—to use release papers, such as glassine, HDPE or LDPE release papers, for example, which in one embodiment have siliconization as a release layer.

It is preferred, however, to use a release film. In one very preferred embodiment the release film possesses siliconization as a release means. Furthermore, the film release liner ought to possess an extremely smooth surface, and so no structuring of the PSA is performed by the release liner. This is preferably achieved through the use of antiblocking-agent-free PET films in combination with silicone systems coated from solution.

### Use

The above-described pressure-sensitive adhesives and pressure-sensitive adhesive tapes are suitable particularly for use in optical applications, where preferably permanent bonds are performed with residence times of greater than one month.

A single-sided pressure-sensitive adhesive tape is suitable especially for the bonding, for example, of glass windows, where the pressure-sensitive adhesive tape may take on an antisplinter protection function or, as a sun protection film, possesses UV-absorbing and heat-absorbing effect.

Moreover, double-sided pressure-sensitive adhesive tapes may be used for the bonding of touch panels to displays, or membrane touch switches may be provided with protection films, or antiscratch films may be bonded, or the bonding of ITO films for capacitive touch panels may be performed.

### Test Methods

### A. Refractive Index

The refractive index of the pressure-sensitive adhesive was measured in a film with a thickness of 25 μm, using the Optronic instrument from Krüss, at 25° C. with white light (λ=550 nm±150 nm) in accordance with the Abbe principle. For temperature stabilization, the instrument was operated in conjunction with a thermostat from Lauda.

### B. Bond Strength

The peel strength (bond strength) was tested in accordance with PSTC-101. The adhesive tape is applied to a glass plate. A strip of the adhesive tape, 2 cm wide, is bonded by being rolled over back and forth three times with a 2 kg roller. The plate is clamped in, and the self-adhesive strip is peeled via its free end on a tensile testing machine at a peel angle of 180° and at a speed of 300 mm/min. The force is reported in N/cm.

### C. Transmittance

The transmittance at 550 nm is determined in accordance with ASTM D1003. The specimen measured was the assembly made up of optically transparent PSA and glass plate.

### D. Haze

The haze is determined in accordance with ASTM D1003.

### E. Light Stability

The assembly made up of PSA and glass plate, with a size of 4×20 cm², is irradiated for 300 hours using Osram Ultra Vitalux 300 W lamps at a distance of 50 cm. Following irradiation, the transmittance is determined by test method C.

### F. Climatic Cycling Test

The PSA is adhered as a single-sided pressure-sensitive adhesive tape (50 g/m² coatweight, 50 μm PET film of type Mitsubishi RNK 50) to a glass plate, without air bubbles. The dimensions of the test strip are 2 cm width and 10 cm length. The bond strength to glass is determined by test method B.

In parallel, a bonded assembly of this kind is placed in a climatic cycling cabinet and stored for 1000 cycles. One cycle includes:
storage at −40° C. for 30 minutes
heating to 85° C. within 5 minutes
storage at 85° C. for 30 minutes
cooling to −40° C. within 5 minutes

After the climatic cycling test, the bond strength is determined again by test method B.

### G. Humidity Test

The PSA is adhered as a single-sided pressure-sensitive adhesive tape (50 g/m² coatweight, 50 μm PET film of type Mitsubishi RNK 50) to a glass plate, without air bubbles. The dimensions of the test strip are 2 cm width and 10 cm length. The bond strength to glass is determined by test method B.

In parallel, a bonded assembly of this kind is placed in a climatic cycling cabinet and stored for 1000 hours at 60° C. and 95% relative humidity. Subsequently, the bond strength is determined again by test method B.

### EXAMPLES

Coating operations in the examples took place on a conventional laboratory coating unit for continuous coating. Coating was carried out in an ISO 5 clean room according to ISO standard 14644-1. The web width was 50 cm. The width of the coating gap was variably adjustable between 0 and 1 cm. The length of the heating tunnel was around 12 m. The temperature in the heating tunnel was divisible into four zones, and was freely selectable in each zone between room temperature and 120° C.

A customary multicomponent mixing and metering unit with a dynamic mixing system was used. The mixing head was designed for two liquid components. The mixing rotor had a variable speed up to a maximum of approximately 5000 rpm. The metering pumps of this unit were gear pumps with a conveying performance of approximately 2 l/min at maximum.

The polyol components were prepared in a customary heatable and evacuatable mixing tank. During the mixing operation, of approximately two hours in each case, the temperature of the mixture was set at approximately 70° C., with reduced pressure applied for the degassing of the components.

The table below lists the base materials used in preparing the polyurethane PSAs, in each case with trade name and manufacturer. The stated raw materials are all freely available commercially.

TABLE 1
Base materials used for preparing the polyurethane PSAs,
with trade name and manufacturer

| | Chemical basis | |
|---|---|---|
| | Average molar mass | Manufacturer/ |
| Trade name | OH or NCO number | supplier |
| Desmophen 1262 BD ® | Polypropylene glycol, | Bayer |
| | Diol (M = 430) | |
| | (4661 mmol OH/kg) | |
| Desmophen 1380 BT ® | Polypropylene glycol, | Bayer |
| | Triol (M = 450) | |
| | (6774 mmol OH/kg) | |
| Desmophen 5035 BT ® | Polypropylene glycol, | Bayer |
| | Triol (M = 4800) | |
| | (624 mmol OH/kg) | |
| Vestanat IPDI ® | Isophorone diisocyanate | Degussa-Hüls |
| | (M = 222.3) | |
| | (8998 mmol NCO/kg) | |
| | Bismuth trisneodecanoate | |
| | CAS No. 34364-26-6 | |
| Mark DBTL ® | Dibutyltin dilaurate | Nordmann, |
| | | Rassmann |
| Tinuvin 292 ® | Sterically hindered amine, | Ciba |
| | light stabilizer | |
| Tinuvin 400 ® | Triazine derivative, UV | Ciba |
| | protectant | |
| Aerosil R202 ® | Hydrophobized fumed silica | Degussa-Hüls |
| Tinuvin 123 ® | Sterically hindered amine, | Ciba |
| | light stabilizer | |
| Stabaxol P 200 ® | Polymeric carbodiimide | Rheinhausen |
| Irganox 1135 ® | 3,5-Bis(1,1-dimethylethyl)- | Ciba |
| | 4-hydroxy-C7-C9 branched | |
| | alkyl ester | |
| | CAS: 125643-61-0 | |
| Irganox 1520 ® | CAS: 110553-27-0 | Ciba |
| | 2-Methyl-4,6-bis[(octylthio)- | |
| | methyl]phenol | |
| Irganox 1726 ® | 4,6-Bis(dodecylthiomethyl)- | Ciba |
| | o-cresol | |
| | CAS: 110675-26-8 | |
| Irgafos 126 ® | Bis(2,4-di-tert- | Ciba |
| | butylphenyl)pentaerythritol | |
| | diphosphite | |
| | CAS: 26741-53-7 | |
| Voranol P400 ® | Polypropylene glycol, | Dow |
| | Diol (M = 400) | |
| | (4643 mmol KOH/kg) | |
| Voranol CP 6055 ® | Polypropylene glycol, | Dow |
| | Triol (M = 6000) | |
| | (490 mmol KOH/kg) | |
| Kristalflex 85 ® | Monomer resin of | Eastman |
| | styrene/α-methylstyrene | |
| | type | |
| | (M = 750) | |
| Piccotac 1100 E ® | Aliphatic hydrocarbon resin | Eastman |
| | (M = 950) | |

### Comparative Examples

### Comparative Example 1 (C1)

Polyurethane composition: NCO/OH ratio: 0.95
Ratio of number of diol-OH/number of triol-OH: 5.0

| | | | Number of OH or |
|---|---|---|---|
| | | | NCO groups, based |
| | | Weight fraction | on percentage |
| | Raw material | [% by weight] | weight fraction |
| A component | Desmophen | 31.8 | 148 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 400 ® | 0.9 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 2 (C2)

Polyurethane composition: NCO/OH ratio: 0.95
Ratio of number of diol-OH/number of triol-OH: 5.0

| | | | Number of OH or |
|---|---|---|---|
| | | | NCO groups, based |
| | | Weight fraction | on percentage |
| | Raw material | [% by weight] | weight fraction |
| A component | Desmophen | 31.8 | 148 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 400 ® | 0.5 | |
| | Tinuvin 123 ® | 0.4 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 3 (C3)

Polyurethane composition: NCO/OH ratio: 0.95
Ratio of number of diol-OH/number of triol-OH: 5.0

| | | | Number of OH or |
|---|---|---|---|
| | | | NCO groups, based |
| | | Weight fraction | on percentage |
| | Raw material | [% by weight] | weight fraction |
| A component | Desmophen | 31.8 | 148 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 123 ® | 0.9 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 4 (C4)

Polyurethane composition: NCO/OH ratio: 0.99
Ratio of number of diol-OH/number of triol-OH: 4.8

| | | | Number of OH or |
|---|---|---|---|
| | | | NCO groups, based |
| | | Weight fraction | on percentage |
| | Raw material | [% by weight] | weight fraction |
| A component | Desmophen | 30.2 | 140.6 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 400 ® | 1.0 | |
| | Tinuvin 123 ® | 0.5 | |
| | Stabaxol P200 ® | 1.0 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 5 (C5)

Polyurethane composition: NCO/OH ratio: 0.99
Ratio of number of diol-OH/number of triol-OH: 4.8

| | | | Number of OH or |
|---|---|---|---|
| | | Weight | NCO groups, based |
| | | fraction | on percentage |
| | Raw material | [% by weight] | weight fraction |
| A component | Desmophen | 30.2 | 140.6 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 400 ® | 0.5 | |
| | Tinuvin 123 ® | 0.5 | |
| | Irganox 1520 ® | 1.5 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 6 (C6)

Polyurethane composition: NCO/OH ratio: 0.99
Ratio of number of diol-OH/number of triol-OH: 4.8

| | | | Number of OH or |
|---|---|---|---|
| | | | NCO groups, based |
| | | Weight fraction | on percentage |
| | Raw material | [% by weight] | weight fraction |
| A component | Desmophen | 30.2 | 140.6 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 400 ® | 0.5 | |
| | Tinuvin 123 ® | 0.5 | |
| | Irganox 1726 ® | 1.5 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 7 (C7)

Polyurethane composition: NCO/OH ratio: 0.99
Ratio of number of diol-OH/number of triol-OH: 4.8

| | | | Number of OH or |
|---|---|---|---|
| | | | NCO groups, |
| | | | based |
| | | Weight fraction | on percentage |
| | Raw material | [% by weight] | weight fraction |
| A component | Desmophen | 30.2 | 140.6 mmol OH |
| | 1262 BD ® | | |
| | Desmophen | 47.3 | 29.5 mmol OH |
| | 5035 BT ® | | |
| | Mark DBTL ® | 0.3 | |
| | Tinuvin 123 ® | 1.5 | |
| | Stabaxol P200 ® | 1.0 | |
| | Aerosil R202 ® | 1.0 | |
| B component | Vestanat IPDI ® | 18.7 | 168.6 mmol NCO |

The test specimen was coated with 50 g/m² of polyurethane PSA on a 75 μm thick polyester release film.

### Comparative Example 8 (C8)

Polyurethane composition: NCO/OH ratio: 0.7
Ratio of number of diol-OH/number of triol-OH: 2.5

| | | Weight | Number of OH or |
|---|---|---|---|
| | | fraction | NCO groups, based |
| | | [% by | on percentage |
| | Raw material | weight] | weight fraction |
| A component | Desmophen 1262 BD ® | 21.7 | 101.3 mmol OH |
| | Desmophen 5035 BT ® | 65.0 | 40.5 mmol OH |
| | Bismuth | 0.3 | |
| | trisneodecanoate | | |
| | Tinuvin 292 ® | 0.5 | |
| | Tinuvin 400 ® | 0.4 | |
| | Aerosil R202 ® | 1.0 | |
| B component | Vestanat IPDI ® | 11.1 | 99.3 mmol NCO |

The test specimen was coated with 50 g/m² of polyurethane PSA on a 75 μm thick polyester release film.

### Comparative Example 9 (C9)

Polyurethane composition: NCO/OH ratio: 1.02
Ratio of number of diol-OH/number of triol-OH: 1.0

| | | Weight | Number of OH or |
|---|---|---|---|
| | | fraction | NCO groups, based |
| | | [% by | on percentage |
| | Raw material | weight] | weight fraction |
| A component | Desmophen 1262 BD ® | 35.6 | 166.0 mmol OH |
| | Desmophen 1380 BT ® | 24.6 | 166.0 mmol OH |
| | Bismuth | 0.3 | |
| | trisneodecanoate | | |
| | Tinuvin 292 ® | 0.3 | |
| | Tinuvin 400 ® | 0.6 | |
| | Aerosil R202 ® | 1.0 | |
| B component | Vestanat IPDI ® | 37.6 | 338.6 mmol NCO |

The test specimen was coated with 50 g/m² of polyurethane PSA on a 75 μm thick polyester release film.

### Comparative Example 10 (C10)

Polyurethane composition: NCO/OH ratio: 1.0
Ratio of number of diol-OH/number of triol-OH: 4.0

| | | | Number of OH or |
|---|---|---|---|
| | | Weight | NCO groups, based |
| | | fraction | on percentage |
| | Raw material | [% by weight] | weight fraction |
| A | Voranol P 400 ® | 21.6 | 100.17 mmol OH |
| component | Voranol CP 6055 ® | 51.1 | 25.04 mmol OH |
| | Kristalex F85 ® | 10.0 | |
| | Bismuth | 0.5 | |
| | trisneodecanoate | | |
| | Tinuvin 292 ® | 0.5 | |
| | Tinuvin 400 ® | 1.0 | |
| | Aerosil R202 ® | 2.0 | |
| B | Vestanat IPDI ® | 13.9 | 125.22 mmol NCO |
| component | | | |

The test specimen was coated with 50 g/m² of polyurethane PSA on a 75 μm thick polyester release film.

### Comparative Example 11 (C11)

Polyurethane composition: NCO/OH ratio: 1.0
Ratio of number of diol-OH/number of triol-OH: 1.0

| | | | Number of OH or |
|---|---|---|---|
| | | | NCO groups, based |
| | | Weight fraction | on percentage |
| | Raw material | [% by weight] | weight fraction |
| A | Voranol P 400 ® | 7.5 | 34.94 mmol OH |
| component | Voranol CP 6055 ® | 71.3 | 34.94 mmol OH |
| | Piccotac 1100 E | 10.0 | |
| | Bismuth | 0.5 | |
| | trisneodecanoate | | |
| | Tinuvin 292 ® | 0.5 | |
| | Tinuvin 400 ® | 1.0 | |
| | Aerosil R202 ® | 2.0 | |
| B | Vestanat IPDI ® | 7.8 | 69.88 mmol NCO |
| component | | | |

The test specimen was coated with 50 g/m² of polyurethane PSA on a 75 μm thick polyester release film.

### Inventive Examples

All inventive examples were selected such that there were no acid functions present.

### Example 1

Polyurethane composition: NCO/OH ratio: 0.99
Ratio of number of diol-OH/number of triol-OH: 4.8

| | | Weight | Number of OH or |
|---|---|---|---|
| | | fraction | NCO groups, based |
| | | [% by | on percentage weight |
| | Raw material | weight] | fraction |
| A | Desmophen 1262 BD ® | 30.2 | 140.6 mmol OH |
| component | Desmophen 5035 BT ® | 47.3 | 29.5 mmol OH |
| | Mark DBTL ® | 0.3 | |
| | Tinuvin 400 ® | 1.0 | |
| | Tinuvin 123 ® | 0.5 | |
| | Irganox 1135 ® | 1.0 | |
| | Stabaxol P200 ® | 1.0 | |
| | Aerosil R202 ® | 1.0 | |
| B | Vestanat IPDI ® | 17.7 | 160.2 mmol NCO |
| component | | | |

The test specimen was coated with 50 g/m² of polyurethane PSA on a 75 μm thick polyester release film.

### Example 2

Polyurethane composition: NCO/OH ratio: 0.99
Ratio of number of diol-OH/number of triol-OH: 4.8

| | | Weight | Number of OH or |
|---|---|---|---|
| | | fraction | NCO groups, based |
| | | [% by | on percentage weight |
| | Raw material | weight] | fraction |
| A | Desmophen 1262 BD ® | 30.2 | 140.6 mmol OH |
| component | Desmophen 5035 BT ® | 47.3 | 29.5 mmol OH |
| | Mark DBTL ® | 0.3 | |
| | Tinuvin 400 ® | 1.0 | |
| | Tinuvin 123 ® | 0.5 | |
| | Irganox 1135 ® | 0.5 | |
| | Stabaxol P200 ® | 1.5 | |
| | Aerosil R202 ® | 1.0 | |
| B | Vestanat IPDI ® | 17.7 | 160.2 mmol NCO |
| component | | | |

The test specimen was coated with 50 g/m² of polyurethane PSA on a 75 μm thick polyester release film.

### Example 3

Polyurethane composition: NCO/OH ratio: 0.99
Ratio of number of diol-OH/number of triol-OH: 4.8

| | | Weight | Number of OH or |
|---|---|---|---|
| | | fraction | NCO groups, based |
| | | [% by | on percentage weight |
| | Raw material | weight] | fraction |
| A | Desmophen 1262 BD ® | 30.2 | 140.6 mmol OH |
| component | Desmophen 5035 BT ® | 47.3 | 29.5 mmol OH |
| | Mark DBTL ® | 0.3 | |
| | Tinuvin 400 ® | 0.5 | |
| | Tinuvin 123 ® | 0.5 | |
| | Irganox 1135 ® | 0.5 | |
| | Stabaxol P200 ® | 1.0 | |
| | Irgafos 126 ® | 0.5 | |
| | Irganox 1520 ® | 0.5 | |
| | Aerosil R202 ® | 1.0 | |
| B | Vestanat IPDI ® | 17.7 | 160.2 mmol NCO |
| component | | | |

The test specimen was coated with 50 g/m² of polyurethane PSA on a 75 μm thick polyester release film.

### Example 4

Polyurethane composition: NCO/OH ratio: 0.74
Ratio of number of diol-OH/number of triol-OH: 2.5

| | | Weight | Number of OH or |
|---|---|---|---|
| | | fraction | NCO groups, based |
| | | [% by | on percentage |
| | Raw material | weight] | weight fraction |
| A component | Desmophen 1262 BD ® | 20.6 | 96.2 mmol OH |
| | Desmophen 5035 BT ® | 61.8 | 38.5 mmol OH |
| | Bismuth trisneodecanoate | 0.3 | |
| | Tinuvin 400 ® | 1.5 | |
| | Tinuvin 123 ® | 1.0 | |
| | Irganox 1135 ® | 1.2 | |
| | Stabaxol P200 ® | 1.5 | |
| | Aerosil R202 ® | 1.0 | |
| B component | Vestanat IPDI ® | 11.1 | 99.3 mmol NCO |

The test specimen was coated with 50 g/m² of polyurethane PSA on a 75 μm thick polyester release film.

### Example 5

Polyurethane composition: NCO/OH ratio: 1.0
Ratio of number of diol-OH/number of triol-OH: 4.0

| | | Weight | Number of OH or |
|---|---|---|---|
| | | fraction | NCO groups, based |
| | | [% by | on percentage |
| | Raw material | weight] | weight fraction |
| A component | Voranol P 400 ® | 21.6 | 100.17 mmol OH |
| | Voranol CP 6055 ® | 51.1 | 25.04 mmol OH |
| | Kristalex F85 ® | 7.4 | |
| | Bismuth trisneodecanoate | 0.5 | |
| | Tinuvin 123 ® | 0.5 | |
| | Tinuvin 400 ® | 1.0 | |
| | Irganox 1135 ® | 1.0 | |
| | Stabaxol P200 ® | 1.0 | |
| | Aerosil R202 ® | 2.0 | |
| B component | Vestanat IPDI ® | 13.9 | 125.22 mmol NCO |

The test specimen was coated with 50 g/m² of polyurethane PSA on a 75 μm thick polyester release film.

### Results

Following production of test specimens, the refractive index was determined by test method A, to start with, for all of the inventive and comparative examples. The results are summarized in table 2.

TABLE 2

| | Refractive index |
|---|---|
| Example | (test A) |
| 1 | 1.49 |
| 2 | 1.49 |
| 3 | 1.49 |
| 4 | 1.49 |
| 5 | 1.51 |
| C1 | 1.49 |
| C2 | 1.49 |
| C3 | 1.49 |
| C4 | 1.49 |
| C5 | 1.49 |
| C6 | 1.49 |
| C7 | 1.49 |
| C8 | 1.49 |
| C9 | 1.49 |
| C10 | 1.51 |
| C11 | n.d. |

From the values measured it is evident that all of the inventive examples have achieved the desired range of greater than 1.49, as have comparative examples C1 to C10. Only comparative example 11 was too cloudy, and no refractive index was determined. For the resin-blended versions C10 and 5, somewhat higher refractive indices were measured.

In the following step, the instantaneous bond strengths to glass were determined for all of the inventive and comparative examples. Measurement in this case took place at a 180° angle. Table 3 below sets out the results.

TABLE 3

| Example | Bond strength (test B) |
|---|---|
| 1 | 5.7 N/cm |
| 2 | 5.8 N/cm |
| 3 | 5.6 N/cm |
| 4 | 6.0 N/cm |
| 5 | 6.6 N/cm |
| C1 | 5.8 N/cm |
| C2 | 5.8 N/cm |
| C3 | 5.6 N/cm |
| C4 | 5.5 N/cm |
| C5 | 5.7 N/cm |
| C6 | 5.7 N/cm |
| C7 | 5.8 N/cm |
| C8 | 6.1 N/cm |
| C9 | 0.2 N/cm |
| C10 | 6.8 N/cm |
| C11 | 0.1 N/cm |

From table 3 it is evident that all of the inventive examples are suitable for permanent adhesive bonding. Comparative examples C9 and C11, in contrast, exhibit bond strengths which are much too low. C9 is an example showing that the right composition of the polyisocyanates and polyols is critical in order to realize a sufficiently high bond strength. C11, again, is an example of microphase separation, generated by the incompatibility of the resin, which lowers the achievable bond strengths.

For further optical determination, measurements of transmittance and of haze were conducted on all of the inventive and comparative examples. The results are listed in table 4.

TABLE 4

| Example | Transmittance (test C) | Haze (test D) |
|---|---|---|
| 1 | 93% | 0.4% |
| 2 | 93% | 0.5% |
| 3 | 92% | 0.9% |
| 4 | 93% | 0.6% |
| 5 | 92% | 1.1% |
| C1 | 93% | 0.4% |
| C2 | 93% | 0.7% |
| C3 | 92% | 0.6% |
| C4 | 92% | 1.0% |
| C5 | 92% | 0.9% |
| C6 | 93% | 0.8% |
| C7 | 92% | 1.0% |
| C8 | 93% | 0.9% |
| C9 | 93% | 1.0% |
| C10 | 92% | 1.1% |
| C11 | 35% | 14.3% |

In table 4 it is apparent that all of the examples have a water-clear transparency, typical of polyurethanes, and hence also a high transmittance. In the measurement, the transmittance is situated at approximately 92% to 93%, limited by reflection losses as a result of the transition from air to the adhesive. Only comparative example 11 (C11) lies well below the requirements, owing to the very severe hazing. These results are confirmed once again by the measurements of the haze values, and are founded on the resin incompatibility.

Subsequently, furthermore, various aging investigations were carried out. First, a light stability test was carried out by test method E. This test examines whether long sunlight exposure causes discoloration or yellowing. This is particularly important for optical applications which are subject to long-term irradiation, such as by a display, for example, and/or are used outdoors. The results are summarized in table 5.

TABLE 5

| | Transmittance after light |
|---|---|
| Example | stability test (test E) |
| 1 | 91% |
| 2 | 91% |
| 3 | 90% |
| 4 | 92% |
| 5 | 91% |
| C1 | 86% |
| C2 | 85% |
| C3 | 85% |
| C4 | 86% |
| C5 | 92% |
| C6 | 92% |
| C7 | 86% |
| C8 | 85% |
| C9 | 86% |
| C10 | 84% |
| C11 | 32% |

From table 5 it is apparent that the comparative examples C1 to C4 and also C7 to C11 exhibit a distinct drop in transmittance. In all of these examples, different light stabilizers based on sterically hindered amines were put in place, but evidently—even in different combinations and with different proportions—do not attain sufficient stabilization. As a result of the yellowing after the light stability test, such adhesive formulations are not suitable for optical applications. All of the inventive examples, in contrast, exhibit very good stability and only a very slight drop, or none at all, in transmittance. This is likewise the case for comparative examples C4 and C5, which additionally contain sterically hindered phenols with sulfur in the side groups.

A further aging test includes climatic cycling. Here, the exposure of the adhesive to very different climatic conditions is simulated, as may be the case, again, in optical applications outdoors. The climatic cycling test was carried out by test method F. The results are set out in table 6.

TABLE 6

| | Bond strength after | |
|---|---|---|
| | climatic cycling storage | |
| Example | (test F) | |
| 1 | 5.9 | N/cm |
| 2 | 6.0 | N/cm |
| 3 | 5.6 | N/cm |
| 4 | 6.3 | N/cm |
| 5 | 7.1 | N/cm |
| C1 | 6.0 | N/cm |
| C2 | 6.1 | N/cm |
| C3 | 5.7 | N/cm |
| C4 | 5.8 | N/cm |
| C5 | 5.4 | N/cm* |
| C6 | 5.5 | N/cm* |
| C7 | 5.5 | N/cm |
| C8 | 6.0 | N/cm |
| C9 | >0.1 | N/cm |
| C10 | 2.4 | N/cm |
| C11 | >0.1 | N/cm |

*The specimens exhibited a brown coloration after the climatic cycling test

The measurements from table 6 illustrate how comparative specimens C9 and C11 in particular exhibit very low bonding strengths after the climatic cycling test. C9 and C11, however, already had very low bond strengths at the beginning. C10, on the other hand, also shows a significant loss.

As a final measurement, a humidity test was carried out, once more, with all of the inventive and comparative examples. The intention here is to ascertain whether the PSA is stable in outdoor applications or in a tropical climate with high atmospheric humidity. The results of measurement for these investigations are set out in table 7.

TABLE 7

| | Bond strength after |
|---|---|
| | humidity storage |
| Example | (test G) |
| 1 | 5.5 N/cm |
| 2 | 5.4 N/cm |
| 3 | 5.3 N/cm |
| 4 | 5.8 N/cm |
| 5 | 6.3 N/cm |
| C1 | 0.3 N/cm |
| C2 | 0.2 N/cm |
| C3 | 0.3 N/cm |
| C4 | 4.8 N/cm |
| C5 | 0.3 N/cm |
| C6 | 0.4 N/cm |
| C7 | 5.9 N/cm |
| C8 | 0.4 N/cm |
| C9 | >0.1 N/cm |
| C10 | 0.5 N/cm |
| C11 | >0.1 N/cm |

The results of measurement show that all of the comparative examples have a very low bond strength after humidity storage. In contrast, the inventive examples exhibit a very high humidity resistance.

In summary, the results of measurement show that only very particular PSAs with very defined adhesive formulations are able to meet all of the requirements. It was found that aging inhibitors in particular combinations also exhibit activity. Additions of carbodiimide as well are necessary in order to achieve humidity resistance. Furthermore, all of the inventive examples meet the requirements in relation to optical transparency and bond strengths, for permanent applications as well.

The inventive examples are therefore very well suited for use for optical applications. Typical applications are, for example, the bonding of glass windows for antisplinter protection or as sunlight protection, or the bonding of touch panels or membrane touch switches, or the bonding of antiscratch films, or the bonding of ITO films for capacitive touch panels. In order to examine these properties, adhesive bonds were made once again to an ITO film from Nitto Denko, and then, in contact with examples 1 to 5, the electrical conductivity was determined as a function of time and on storage at 60° C. The measurements showed that the electrical conductivity remained constant within a band of ±10% over 4 weeks at 60° C. The inventive examples therefore exhibit very good neutrality with respect to ITO, and do not damage the electrical conductivity of this material.

1. A pressure-sensitive adhesive based on polyurethane, wherein the polyurethane is composed of the following starting materials, reacted catalytically with one another, in the stated proportions:
a) at least one aliphatic or alicyclic polyisocyanate, the functionality thereof in each case being less than or equal to 3
b) a combination of at least one polypropylene glycol diol and at least one polypropylene glycol triol, where the ratio of the number of hydroxyl groups in the diol component to the number of hydroxyl groups in the triol component is less than 10, the ratio of the number of isocyanate groups to the total number of hydroxyl groups is between 0.65 and 1.2, and where the diols and triols alternatively are each selected and combined as follows:
diols having a molecular weight of less than or equal to 1000 are combined with triols whose molecular weight is greater than or equal to 1000,
diols having a molecular weight of greater than 1000 are combined with triols whose molecular weight is less than 1000
c) at least one light stabilizer based on an aromatically substituted triazine, with a fraction of 0.2%-2% by weight, and at least one aminically hindered light stabilizer, with a fraction of 0.2%-2% by weight
d) at least one aging inhibitor based on a sterically hindered phenol, with a fraction of 0.2%-2% by weight
e) a carbodiimide, with a fraction of 0.25%-2.5% by weight.

2. The pressure-sensitive adhesive of claim 1, wherein as polyisocyanate aliphatic or alicyclic diisocyanates are/is present as starting material.

3. The pressure-sensitive adhesive of claim 1, wherein the polyurethane is prepared using a bismuth carboxylate-containing or bismuth carboxylate derivative-containing catalyst or catalyst mixture.

4. The pressure-sensitive adhesive of claim 1 wherein carbodiimide 1-ethyl-3-(3-dimethylaminopropyl)carbodiimide hydrochloride is present as starting material.

5. The pressure-sensitive adhesive of claim 1 wherein the pressure-sensitive adhesive is free from acid functions.

6. The pressure-sensitive adhesive of claim 1 wherein the pressure-sensitive adhesive has an ASTM D 1003 luminous transmittance of at least 86% and an ASTM D 1003 haze value of not more than 5%.

7. A method for the bonding of optical films comprising using a pressure-sensitive adhesive of claim 1 to bond optical films.

8. The pressure-sensitive adhesive of claim 2 wherein isophorone diisocyanate is present as a starting material.

9. The pressure-sensitive adhesive of claim 2 wherein the polyisocyanate has an unsymmetrical molecular structure.
